(19) United States
(12) Patent Application Publication
(10) Pub. No.: US 2015/0164040 A1
(43) Pub. Date: Jun. 18, 2015

(54) Animal Litter Box

(71) Applicant: Monica Anderson, Roberts, MT (US)

(72) Inventor: Monica Anderson, Roberts, MT (US)

(21) Appl. No.: 14/491,619

(22) Filed: Sep. 19, 2014

Related U.S. Application Data
(60) Provisional application No. 61/915,627, filed on Dec. 13, 2013.

(51) Int. Cl. A01K 1/01

(52) U.S. Cl. CPC A01K 1/0125

(57) ABSTRACT

Disclosed is a disposable animal litter box apparatus having a rectangular prism housing composed of connected walls including a front wall, rear wall, side walls, a top wall and a bottom wall forming an interior volume. The device includes handles, an entryway, fastening straps, and a plurality of integral accordion style pleats. The device further includes a litter tray having a removable cover and an integral shelf and tab, wherein the tray can be placed within the housing and can have pre-filled litter. A user can manually flip the litter tray via gripping the tab, causing the litter therein to move downward, wherein the shelf prevents the litter from spilling therefrom whereby the litter tray rests against the rear wall in a vertical orientation. Thereafter, the front and rear walls are manually pushed toward one another to collapse the housing via the pleats and is secured by the fastening straps.

### CROSS REFERENCE TO RELATED APPLICATION

This application claims the benefit of U.S. Provisional Application No. 61/915,627 filed on Dec. 13, 2013. The above identified patent application is herein incorporated by reference in its entirety to provide continuity of disclosure.

### BACKGROUND OF THE INVENTION

1. Field of the Invention

The present invention relates to animal litter boxes. More specifically, the present invention pertains to a disposable animal litter box having fastening straps, an entryway or opening, handles, a litter tray with an integral shelf and tab, a ledge and accordion style pleats in order to allow placement of the invention into a collapsed position for disposal. The invention can be pre-filled with litter and prevents litter from leaking therefrom when in use and when placed in a collapsed position.

Traditional litter boxes are typically square or rectangular in shape and do not provide an enclosed housing for the cat to enter. Further, these litter boxes are not disposable, do not provide handles and are intended to remain within a home for prolonged periods of time. As such, traditional litter boxes are not easily transported and cannot be easily disposed of when worn out and no longer useful. Further, conventional litter boxes are difficult to transport, thus there exists a need for a disposable litter box that can be used temporarily and as such, provides a more sanitary litter box apparatus to be used for a short period of time.

More practical classes of litter boxes provide for structures that are disposable, shippable, and provide pre-filled litter. Still, such litter boxes do not provide a removable litter tray having a shelf in order to prevent spillage of litter and further do not provide a plurality of pleats that enable the user to place the device in a collapsed position in a one pass motion.

Accordingly, the present invention relates to a new and improved animal litter box having a housing structure incorporating handles, a removable litter tray with a tab and shelf to prevent litter spillage, an entryway, and a plurality of pleats integral therewith. Specifically, the present invention provides an animal litter box that enables a user to upwardly flip the litter tray located within the housing, wherein the shelf of the tray will prevent spillage of litter therefrom. Thereafter, the user can collapse the animal litter box which is accomplished via the plurality of pleats.

2. Description of the Prior Art

Devices have been disclosed in the prior art that relate to animal litter boxes and/or containers. These include devices that have been patented and published in patent application publications. These devices generally relate to animal litter boxes and/or containers that are collapsible, portable, and disposable. The following is a list of devices deemed most relevant to the present disclosure, which are herein described for the purposes of highlighting and differentiating the unique aspects of the present invention, and further highlighting the drawbacks existing in the prior art.

Specifically, U.S. Patent Application Publication Number 2012/0234252 to Donta discloses a disposable, and collapsible litter box that includes an animal entryway having a removable seal in order to seal the entry for preventing litter from escaping when the litter box is in a collapsed position. The device further provides a litter box that can be shipped pre-filled with animal litter, such as cat litter. This device, however, does not provide an accordion style folding mechanism and a removable litter tray.

U.S. Pat. No. 6,487,990 to McNew describes a one piece disposable litter box that can be utilized by cats and other small animals and provides folding side panels and folding flaps. The device provides handles that are latched onto the folded side panels and additionally provides a spill resistant container. The device is compact and can be easily shipped, stored, and disposed of. However, McNew fails to disclose a litter box having fastening straps in order to maintain the litter box in a compact position for transportation and disposal thereof, a removable litter tray and accordion style pleats for collapsing the litter box.

U.S. Pat. No. 4,940,016 to Heath provides for a unitary collapsible and disposable pet litter container that is foldable between a collapsed state for storage and disposal and an erect state for use. The device can be completely enclosed in order to prevent spillage of litter during use by pets. While Heath provides a collapsible litter box, Heath fails to disclose a tray having a cover in order to prevent spillage and to allow the easily disposal thereof. The present invention enables a user to collapse the litter box with a soiled litter tray therein and transport it a trashcan for disposal thereof via handles.

U.S. Patent Application Publication No, 2004/0244708 to Neil presents a litter box that contains a bag of litter and provides four sides thus forming a litter box. The device provides closure panels in order to allow the ingress and egress of cats. Further, the device can be folded into a flat configuration to be disposed of in its entirety. This device however is not collapsible by means of a plurality of accordion-style pleats disposed on the sides of the litter box housing.

U.S. Pat. No. 5,337,700 to Toft allows for a foldable disposable litter container having an outside enclosure, a bottom disposable litter trap, and a roof top, wherein the device is in the form of a castle. The device is water resistant and odor proof and can be folded into a flat configuration. The device provides four distinct and separate parts. This device however, does not provide a wax liner and ledge for the prevention of kitty litter spillage therefrom.

These prior art devices have several known drawbacks. The above described animal litter boxes do not provide for an animal litter box having a water and moisture resistant litter tray that includes a tab which the user can grip, a recess in which the litter tray can rest, cutout handles, a plurality of accordion style pleats, and fastening straps. In light of the devices disclosed in the prior art, it is submitted that the present invention substantially diverges in design elements from the prior art and consequently it is clear that there is a need in the art for an improvement to existing animal litter box devices. In this regard the instant invention substantially fulfills these needs.

### SUMMARY OF THE INVENTION

In view of the foregoing disadvantages inherent in the known types of disposable animal litter boxes now present in the prior art, the present invention provides a new disposable litter box wherein the same can be utilized for providing convenience for the user when transporting and disposing of a litter box.

It is therefore an object of the present invention to provide a new and improved animal litter box device that has all of the advantages of the prior art and none of the disadvantages.

It is another object of the present invention to provide an animal litter box that is disposable.

Another object of the present invention is to provide a collapsible animal litter box having accordion style pleats.

It is another object of the present invention to provide an animal litter box that has fastening straps for maintaining the device in a collapsed configuration.

Another object of the present invention is to provide an animal litter box that provides pre-filled litter.

Another object of the present invention is to provide an animal litter having a litter tray with an integral tab and shelf for containing litter and preventing spillage therefrom.

Another object of the present invention is to provide an animal litter box that provides a tray having a wax liner for moisture and/or water resistance.

Another object of the present invention is to provide an animal litter box having a litter tray with a removable cover.

Yet another object of the present invention is to provide an animal litter box having an entryway or opening for the ingress and egress of animals.

Yet another object of the present invention is to provide an animal litter box having a ledge to prevent the litter tray from becoming displaced and to prevent litter from spilling therefrom.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the animal litter box of the present invention in an assembled configuration.

FIG. 2 shows a perspective view of the animal litter box apparatus in a collapsed position.

FIG. 3 shows an interior view of the animal litter box having a litter tray therein and showing the way in which the litter tray can be lifted from the recess of the bottom wall of the animal litter box apparatus and flipped upward toward the rear wall thereof.

### DETAILED DESCRIPTION OF THE INVENTION

Reference is made herein to the attached drawings. Like reference numerals are used throughout the drawings to depict like or similar elements of the animal litter box apparatus. For the purposes of presenting a brief and clear description of the present invention, the preferred embodiment will be discussed as used for animal litter box purposes, wherein an animal can defecate and/or urinate into a litter box held therein, flip the litter box upward toward the rear wall to rest thereagainst and can place the animal litter box into a collapsed position and fasten it for disposal thereof. The figures are intended for representative purposes only and should not be considered to be limiting in any respect.

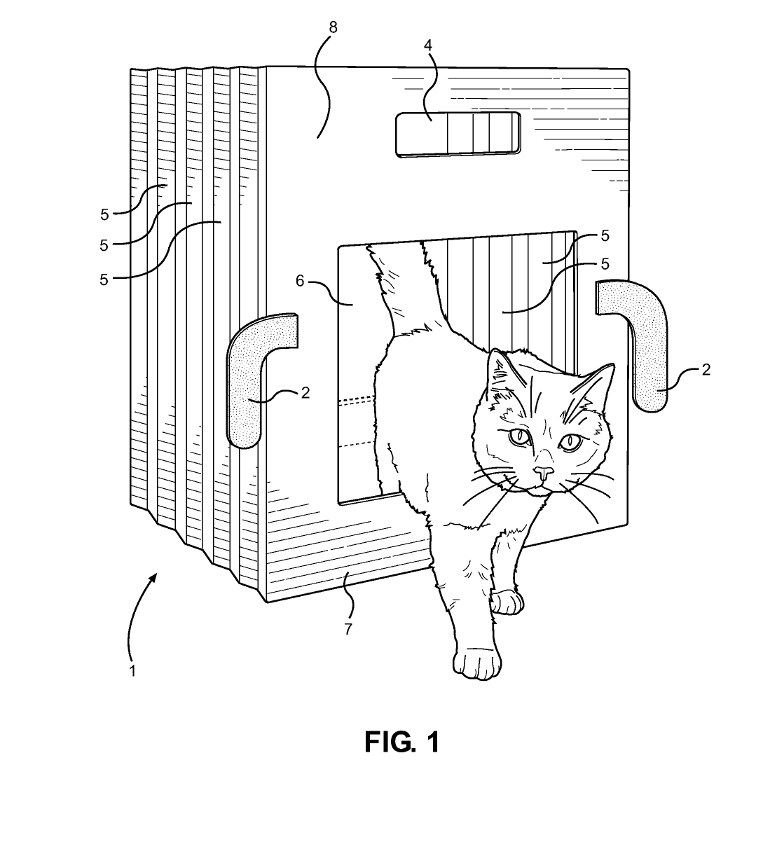

Referring now to FIG. 1, there is shown a perspective view of the animal litter box 1 apparatus having a litter tray therein. The animal litter box 1 comprises a rectangular housing having a front wall 8, a rear wall (not shown), a first side wall a second side wall, a top wall and a bottom wall, wherein each wall provides an outer perimeter edge, a top end and a bottom end. The outer perimeter edges of each of the walls described above are connected to one another, respectively, thus forming a rectangular prism having an enclosed interior volume. The animal litter box 1 of the present invention is preferably composed of disposable materials such as cardboard, paper, plastic, recycled materials and/or other suitable materials, so that it is sturdy yet lightweight and can be easily disposed of.

The litter box 1 of the present invention is collapsible and includes a plurality of accordion style pleats 5. Preferably, the top wall, bottom wall, first side wall, and second side wall of the animal litter box 1 provide a plurality of accordion style pleats 5 that are integral therewith, wherein the user can place the animal litter box 1 into a compact and collapsed position via manually exerting pressure onto the device via pushing the front wall 8 and the rear wall toward one another.

Cutout handles 4 are provided on the top end of the front wall 8 and the top end of the rear wall, wherein the user can place his or her hand and/or fingers within each of the cutout handles 4 and easily transport the animal litter box 1 to a desired location. Further, the front wall 8 includes an entryway or opening 6, wherein the entryway 6 can be a square shaped cutout in a preferred embodiment, in order to allow for the ingress and egress of animals, wherein the entryway 6 is centrally located beneath the cutout handle 4 of the front wall 8. In an alternative embodiment, the entryway 6 can comprise a circular shape, rectangular shape or other suitable shape.

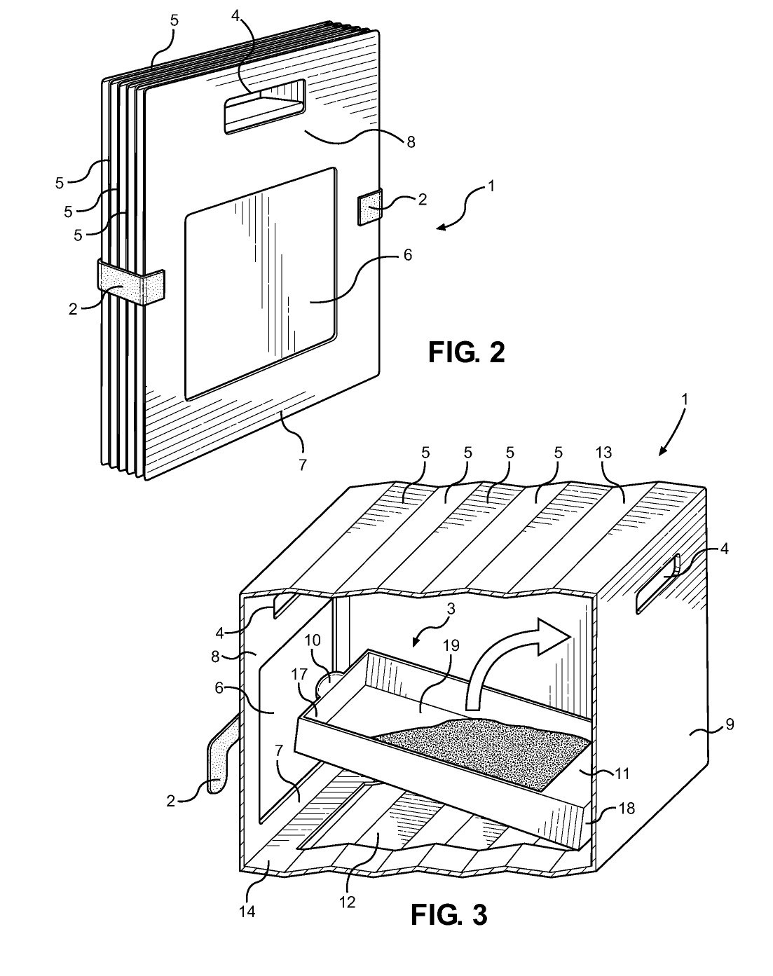

FIG. 2 shows a perspective view of the animal litter box 1 in a collapsed position in an accordion style manner. One or more fastening straps 2 are disposed on each side of the front wall 8 near the perimeter edge thereof. Each fastening strap 2 comprises a first end, a second end, a first side and a second side. The first end of the fastening straps are permanently connected to the front wall 8 near the perimeter edge thereof and the second end of the fastening strap 2 can be removably fastened to the rear wall via an adhesive located on the second side of the fastening strap 2 in a preferred embodiment. However, in alternative embodiments the fastening straps 2 can instead include hook and loop fasteners, buttons, snaps, and/or other suitable fasteners. The user can place the animal litter box apparatus 1 in a collapsed position via applying manual pressure thereto as described above. Once collapsed into a compact configuration, the user can secure and maintain the animal litter box apparatus 1 as such via grasping the fastening straps 2 and pulling and securing the second end of the fastening straps to the rear wall 9 of the device via an adhesive.

When the animal litter box 1 is placed in a collapsed position, the cutout handle 4 of the front wall 8 and the rear wall 9 are drawn toward one another so that the user can place his or her fingers through the cutout handle 4 of the front wall 8 and the cutout handle 4 of the rear wall 9 using only one hand for carrying and transporting the animal litter box apparatus 1 to a garbage can or other disposal area. The user can further place the animal litter box apparatus 1 in a car for transport to a waste disposal site, wherein the animal litter box apparatus 1 once collapsed, will remain in a collapsed position and the used litter in the litter tray will not spill therefrom during transport thereof.

FIG. 3 shows a perspective view of the litter tray 3 and the means in which it is placed into the recess 12 of the bottom wall of the animal litter box apparatus 1 and held therein. The litter tray provides a rectangular shaped structure in a preferred embodiment and can be placed within the enclosed interior volume of the animal litter box 1 and can rest in the recess 12 of the bottom wall 14 of the animal litter box apparatus 1 and can further provide pre-filled litter in a preferred embodiment. The litter tray 3 provides a front wall 17, a rear wall 18, a first side wall and a second side wall and a base 19 having an outer perimeter edge. The front wall 17 and the rear wall 18 oppose one another, wherein the first side wall and the second side wall oppose one another. Each of the litter tray walls described have a top edge, a bottom edge, and side edges, wherein the bottom edges of each of the walls is connected to the base along the outer perimeter edge thereof. The side edges of each of the side walls are connected to one another, respectively forming a rectangular shaped enclosure having a partial open upper in which litter can be placed and held therein. The litter tray 3 may include a wax liner (not shown) for protection thereto. The litter tray 3 is preferably composed of a moisture resistant or waterproof material so that liquid within the litter tray does not seep through the walls of the litter tray or otherwise leak therefrom. The litter tray may further include a removable cover for enclosing the interior volume of the litter tray and the litter and waste therein.

The bottom wall 14 of the animal litter box apparatus 1 provides a recess 12 in which the litter tray 3 can be placed and held therein, wherein the recess 12 is rectangularly shaped in a preferred embodiment and corresponds to the shape and/or structure of the litter tray thus allowing the litter tray 3 to securely rest therein. The recess 12 of the animal litter box apparatus 1 prevents the litter tray 3 from moving and from becoming displaced and/or dislodged therefrom.

The entryway, also known as the opening 6 of the front wall 8 of the animal litter box apparatus 1 is provided beneath the cutout handle 4 of the front wall 8 in a centralized location wherein the entryway 6 is not flush with the bottom wall 14 leaving a space therebelow and thus forming a ledge 7 on the front wall 8. The ledge 7 of the animal litter box apparatus 1 prevents litter from escaping from the litter tray 3 held within the recess 12 in the interior volume of the animal litter box 1 and further hinders the litter tray 3 from removal by an animal.

The rear wall 18 of the litter tray 3 further provides a shelf 11 having an upper edge, two side edges and a bottom edge, wherein the bottom edge of the shelf 11 is connected to the top edge of the rear wall 18. One side edge of the shelf 11 is connected to the top edge of the first side wall and the second side edge of the shelf 11 is connected to the top edge of the second side wall leaving a partially open upper. In this way, when the litter tray 3 is tilted into an inclined position so that the litter tray 3 can be removed by a user, the litter within the tray is prevented from escaping the litter tray 3. The shelf 11 helps to retain the litter within the tray when the tray is tilted. However, the shelf 11 leaves the upper end of the litter tray substantially open so that it does not inhibit an animal from making use of the litter box.

In a preferred embodiment, the front wall of the litter tray 3 can provide a centrally located tab 10 disposed at the top edge thereof. The tab 10 provides an easily grasped surface that allows the user to move the tray. Preferably, the tab is integral with the tray, thus forming a unitary body. The tab 10 provides a semi-circular shape in a preferred embodiment, however the tab 10 can have a circular shape, knob, or other shape that is conducive for manually gripping thereon.

In use, an animal, such as a cat, can enter the interior volume of the animal litter box apparatus 1 through the entryway 6 and step onto the litter tray 3 having litter placed therein whereby the cat can defecate and/or urinate thereon and exit when desired. The user can manually use his or her forefinger and thumb and grip the tab 10 in order to lift the litter tray 3 upward so as to tilt the tray 3 toward the rear wall 9 of the litter box without contaminating his or her hands with litter, feces and/or urine. Once the litter tray 3 has been positioned vertically against the rear wall, the litter held therein moves towards the rear of the tray and is contained by the shelf 11 of the litter tray 3, preventing the spillage of the litter therefrom. The user can place the animal litter box apparatus 1 into a collapsed position as described above via manually pushing the front wall 8 and the rear wall 9 toward one another thus allowing the accordion style pleats 5 of the top wall 13, first side wall, rear wall, and bottom wall 14 to become compressed and compacted thus collapsing the animal litter box apparatus 1.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1-2. (canceled)

3) The collapsible animal litter box of claim 2, wherein said litter tray comprises a wax liner.

4) The collapsible animal litter box of claim 2, wherein said litter tray further comprises a moisture resistant material.

5) The collapsible animal litter box of claim 2, wherein said litter tray further comprises a water resistant material.

6) The collapsible animal litter box of claim 2, said litter tray having pre-filled litter.

7) The collapsible animal litter box of claim 2, said litter tray having a cover removably securable to said partially open upper.

8) The collapsible animal litter box of claim 1, wherein said rectangular housing is composed of cardboard.

9) The collapsible animal litter box of claim 1, wherein said rectangular housing is composed of recyclable materials.

10) The collapsible animal litter box of claim 1 further comprising:
a plurality of fastening straps, said fastening straps having a first end, a second end, a first side, and a second side, wherein said second side provides an adhesive;
said fastening straps being disposed on opposing sides of said front wall, wherein said first end of said fastening straps being permanently affixed to said front wall of said rectangular housing and said second end of said fastening straps being removably securable to said rear wall via said adhesive of said second side of said fastening straps to secure said rectangular housing in a collapsed position for the disposal thereof.

11) The collapsible animal litter box of claim 1, wherein said recess of said bottom wall is centrally located.

12) The collapsible animal litter box of claim 1, wherein said opening is disposed centrally on said front wall so as to form a ledge thereunder on said front wall.

13) The collapsible animal litter box of claim 1, wherein said opening comprises a square shape.

14) The collapsible animal litter box of claim 1, wherein said opening further comprises a circular shape.

15) The collapsible animal litter box of claim 1, wherein said front wall and said rear wall of said rectangular housing each comprise an opening thereon adapted to serve as a handle.
